(19) United States
(12) Patent Application Publication
(10) Pub. No.: US 2004/0027312 A1
(43) Pub. Date: Feb. 12, 2004

(54) Portable information device

(76) Inventors: Norio Owada, Yokohama (JP); Osamu Ebina, Atsugi (JP); Akinori Maeda, Yokohama (JP); Masumi Moritani, Yokohama (JP); Ichiro Ote, Chigasaki (JP); Yoshinobu Ohinata, Yokohama (JP); Akihiro Yoshida, Kawasaki (JP); Taichi Koriyama, Tokyo (JP); Kimihiko Adachi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/392,949

(22) Filed: Mar. 21, 2003

(30) Foreign Application Priority Data
Mar. 27, 2002 (JP) 2002-087393

(51) Int. Cl. G09G 5/00

(52) U.S. Cl. 345/8

(57) ABSTRACT

Hands-free operation is a prerequisite in wearable PCs; a problem in such PCs is that intuitive input or direct input such as pen input or touch panel input is impossible, so that a comfortable input operation cannot be performed. In order to solve this problem, the portable information device of the present invention comprises a portable main body part, and an HMD which is connected to this main body part, and which is mounted on the head. Furthermore, the abovementioned main body part comprises an input display part which displays to the outside image information consisting of a smaller amount of data than the image information displayed on the abovementioned HMD, and which inputs operating information from the outside on a displayed screen, an output part which outputs information to the abovementioned HMD, and a control part which controls the image information that is displayed on the abovementioned HMD on the basis of the operating information that is input in the abovementioned input display part.

### BACKGROUND OF THE INVENTION

1. Field of the Invention

The present invention relates to a portable information device comprising a plurality of display devices that are disposed in respectively different locations, and more particularly relates to a portable information device in which one of the abovementioned plurality of display devices is a head-mounted or face-mounted display device which is mounted on the head or face, and which can display a high-definition large screen.

2. Description of the Related Art

Personal digital assistants (hereafter abbreviated to “PDA”) have been known in the past as portable information devices that are even more compact than notebook type personal computers (“personal computer” is hereafter abbreviated to “PC”). Such PDA ordinarily have dimensions that allow the device to be held in a person's hand, and have a construction in which a display panel consisting of a liquid crystal (LCD) or the like (resolution QVGA approximately 240×320 dots) is disposed on the front surface. The user ordinarily inputs data and commands (input operations) into the PDA by operating a small number of buttons, keys or dials, or a touch panel or pen (stylus) or the like, disposed around the display panel. Furthermore, such a PDA is equipped with a connector that connects a portable telephone, PHS or the like, or a card slot for a flash memory card. Accordingly, although this PDA cannot accommodate a large-capacity memory device (CD-ROM drive or the like), a relatively large amount of information can be handled if a portable telephone/PHS or a flash memory card is used.

However, in a PDA, the display panel is much smaller than that of a notebook personal computer. For example, in cases where documents or drawings of A4 size are to be viewed, it is necessary to view these items by scrolling; accordingly, the entire item cannot be grasped in one glance.

Accordingly, as portable information devices whose main purpose is the viewing of graphic materials such as documents, operating manuals, drawings and the like, there are wearable PCs (hereafter abbreviated to “WPCs”), which are personal computers that are used while attached to the body, in which the main body contains no display part using a liquid crystal or the like that displays images, characters or the like, but in which an HMD (head-mounted display) or FMD (face-mounted display) which is mounted on the head or face and in which images formed on a display element in accordance with image signals are enlarged and focused as virtual images on a virtual screen in front of the eyes is instead connected to the main body. For example, such a WPC is disclosed in Japanese Laid-Open Patent Application No. H9-114543. Examples of HMDs that are used in combination with such a WPC are disclosed in Japanese Laid-Open Patent Application No. H7-325265, Japanese Laid-Open Patent Application No. H9-318905 and the like. Below, HMDs will be described as displays that also include the abovementioned FMDs.

The overall size of the main body of a WPC that has already been developed and marketed by the inventors is approximately 90 mm (width)×140 mm (height)×26 mm (depth); this WPC is designed so that it can be carried in the pocket. Furthermore, a liquid crystal display element is used as the HMD, and this display has an optical system in which (for example) images formed on the liquid crystal display element are reflected by a reflective mirror in front of the eyes and are enlarged and focused as full-color (260,000 color) virtual display images with an image display size of 13 inches and a resolution of SVGA (800×600 dots) on a virtual screen in a spatial position located 60 cm in front of the eyes. The abovementioned reflective mirror is installed in a movable system which allows the mirror to turn up so that the mirror does not cause any interference when the outside scene is viewed; furthermore, the system is a see-through type system which allows the outside scene to be viewed in cases where no image is being viewed. HMDs include single-eye HMDs viewed with a one eye, which have one pair of the abovementioned optical systems, and two-eye HMDs viewed with both eyes, which have two pairs of the abovementioned optical systems. In a WPC, a single-eye HMD which allows work to be performed while viewing images is generally used. Furthermore, it is also conceivable that the WPC main body could be mounted on the waist using a belt. A WPC that is mounted on the waist is disclosed in Japanese Laid-Open Patent Application No. 9-114543.

In a WPC, as is clear from the example disclosed in Japanese Laid-Open Patent Application No. 9-114543, the input of operating information is mainly performed in a hands-free manner by voice-operated means such as speech recognition or the like, eyeball tracking means, electroencephalograph (EEG) or the like. Of course, it would also be possible to allow the input of operating information using a keyboard as an option.

### SUMMARY OF THE INVENTION

While WPCs have a size that allows the device to be held in the hand as described above, a high-definition large screen comparable to that of a personal computer screen can be viewed by means of an HMD with SVGA resolution (800×600 dots) that is used in combination with the WPC. However, in WPCs, as was already mentioned above, images are visually recognized using an HMD that is mounted on the head. Accordingly, the mounting of an HMD is also required in order to view images at a glance in order to check the content stored in external recording media such as flash memory cards or the like (high resolution is not ordinarily required in such cases). Consequently, a problem arises in that the display screen cannot easily be viewed at a glance. Furthermore, in WPCs, hands-free operation is a prerequisite. For example, input operations are performed by operating a cursor position on the screen of the HMD with a mouse, which is a pointing device. Intuitive input or direct input such as pen input or touch panel input of the type used in PDA cannot be used to input operating information, so that easy input operation is impossible.

It is an object of the present invention to solve the abovementioned problems, and to provide a portable information device in which images used to check the content of data or the like in which a high resolution is not required can easily be seen at a glance, and in which the input operation of operating data can easily be accomplished.

In order to solve the abovementioned problems, the portable information device of the present invention is a portable information device comprising a portable main body part, and a head-mounted display which is connected to the abovementioned portable main body part, and which is mounted on the head or face, wherein the abovementioned main body part comprises an input display part which displays to the outside image information consisting of a smaller amount of data than the image information that is displayed on the abovementioned head-mounted display, and which inputs operating information from the outside on the screen that is displayed, an output part which outputs image information to the head-mounted display, and a control part which controls the image information displayed on the abovementioned head-mounted display on the basis of the operating information that is input in the abovementioned input display part. Thus, since the abovementioned input-output display part in which a display screen and an input operation function which inputs specified operating information in accordance with regions of the display screen that correspond to input instruction operating positions are integrated is installed in the abovementioned main body part separately from the head-mounted display that is mounted on the head, and the device is constructed so that instruction operations to the abovementioned portable information device can be performed using the abovementioned input-output display part, the input of operating information is facilitated; furthermore, intuitive input or direct input can be accomplished so that an easy input operation is possible.

Furthermore, since the abovementioned input-output display art is disposed in the portable main body part, the display region is small compared to that of the abovementioned head-mounted display, and the resolution is decreased. Accordingly, image information corresponding to the abovementioned input-output display part and the abovementioned head-mounted display can be produced using the abovementioned first display processing part and the abovementioned second display processing part, and can be respectively displayed.

Furthermore, (for example) icons constituting image information for specified instruction operations that are displayed on the abovementioned head-mounted display can be designated using a designating pointer that is displayed on the abovementioned head-mounted display on the basis of the operating information that is input from the abovementioned input-output display part, and specified operations associated with the abovementioned image information can be performed; accordingly, the input of operating information is facilitated.

Furthermore, the image information that is displayed on the abovementioned head-mounted display can be reduced to an amount of data having a resolution that can be displayed by the abovementioned input-output display part, and this information can be displayed by the abovementioned input-output display part; accordingly, image information can be checked without mounting the abovementioned head-mounted display.

Furthermore, display content attribute information or control information constituting added information for the image information that is displayed in the abovementioned head-mounted display can be displayed on the abovementioned input-output display part, and the image information that is displayed in the abovementioned head-mounted display can be controlled on the basis of input operating information designating the abovementioned information that is displayed on the abovementioned input-output display part; accordingly, control operations are simple.

Furthermore, image information in specified image regions constituting a portion of the image information that is displayed on the abovementioned head-mounted display can be displayed on the abovementioned input-output display part; furthermore, the abovementioned specified image regions that are displayed on the abovementioned input-output display part can be scrolled, and designating scroll bar icons can be operated so that the specified image regions displayed on the abovementioned head-mounted display can be varied. Accordingly, all of the image information that is displayed on the abovementioned head-mounted display can be scrolled and viewed while enlarging the image information in the abovementioned specified image regions by means of the abovementioned input-output display part without mounting the abovementioned head-mounted display.

Furthermore, since the abovementioned input-output display part can be switched to a plurality of functions, image information that corresponds to the application desired by the user can be displayed on the abovementioned input-output display part.

Furthermore, the abovementioned keyboard image can be displayed on the abovementioned input-output display part, and control information or characters can be input by operating the abovementioned keyboard image.

### BRIEF DESCRIPTION OF THE DRAWINGS

FIG. 1 is a schematic block structural diagram of a portable information device illustrating one embodiment of the present invention;

FIG. 2 is an external schematic diagram of the portable information device of the present invention;

FIG. 3 is an external view which shows the use state of the basic device corresponding to mode 0;

FIG. 4 is an external view which shows the use state of the portable information device corresponding to mode 1;

FIG. 5 is an external view which shows the use state of the portable information device corresponding to mode 2;

FIG. 6 is an external view which shows the use state of the portable information device corresponding to mode 3;

FIG. 7 is an external view which shows the use state of the portable information device corresponding to mode 4;

FIG. 8 is a diagram which shows one embodiment of the mode state transition diagram; and

FIG. 9 shows one example of a simplified character input software keyboard.

### DESCRIPTION OF THE PREFERRED EMBODIMENTS

An embodiment of the present invention will be described in detail below with reference to the attached figures. In the respective figures, the same parts are labeled with the same symbols.

In the present invention, a display part with a non-high-definition resolution of approximately QVGA is disposed on the side of the WPC main body in addition to a head-mounted or face-mounted HMD which can display a high-definition large screen, as a display part of the WPC constituting the portable information device, and displays are performed according to the special features of the two display parts.

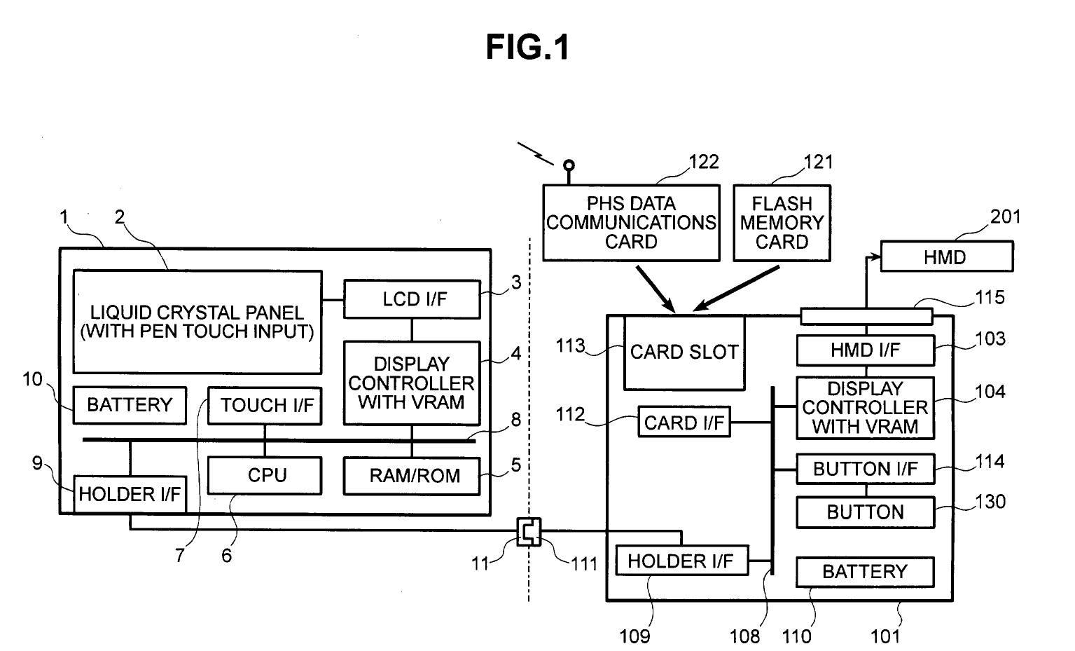

FIG. 1 is a schematic block structural diagram of a portable information device illustrating one embodiment of the present invention. In FIG. 1, a display part of the basic device constituting the PDA is used as a display part with a non-high-definition resolution on the side of the WPC main body.

In FIG. 1, the portable information device of the present invention is constructed from a basic device 1 which is a PDA that can be used independently by itself, a holder 101 which is an expansion device that is added to the basic device 1 in order to obtain a WPC function, and an HMD 201. For example, the basic device 1 and holder 101 are constructed so that these parts can be detachably engaged by means of a concave connector 11 and a convex connector 111. The basic device 1 can be used independently by itself by disconnecting these connectors, and can operate as a WPC when the connectors are engaged. The HMD 201 is detachably connected to the holder 101 by a connector 115. In this case, the HMD 201 need not be detachably connected to the holder 101 by such a connector 115, and a direct connection is also permissible.

The basic device 1 comprises a CPU 6 which performs overall operational control of the portable information device, a memory 5 consisting of a working RAM and a program ROM and that stores the operational control programs of the CPU 6, a liquid crystal panel 2 with a non-high-definition resolution of (for example) QVGA (240×320 dots) which has a pen touch input function, a display controller 4 with a VRAM which is a video memory storing image data that is used to control the display of the liquid crystal display panel 2 via an LCD interface (hereafter abbreviated to “LCD I/F”) 3, a touch I/F 7 which is a pen touch input interface for the liquid crystal display panel 2, a holder I/F 9 which is an interface with the holder 101, and a battery 10 which supplies power to the basic device 1. Furthermore, the CPU 6, memory 5, display controller 4, touch I/F 7 and holder I/F 9 are connected by a bus line 8.

The liquid crystal panel 2 which has a pen touch input function is a display device in which a display screen and an input operating function which detects operating positions for input instruction operations by means of a stylus pen for example and inputs specified operating information in accordance with display screen regions that correspond to these operating positions are integrated.

A plurality of application software programs are stored in the memory 5; in cases where the basic device 1 is used alone, the CPU 6 performs operational control according to application software programs designated by pen touch input, and the necessary displays are performed by the liquid crystal panel 2.

The holder 101 comprises a card slot 113 which takes in information via, for example a flash memory card 121 or PHS data communications card 122 constituting an external recording medium, a card I/F 112 which is an interface for the card, a display controller 104 with a VRAM which is a video memory storing image data that performs display control of the HMD 201 connected by the connector 115 via an HMD I/F 103 which is an interface, a holder I/F 109 which is an interface with the basic device 1, a button I/F 114 which consists of a plurality of buttons 130 and an interface for the same, and a battery 110 which supplies power to the holder 101 and HMD 201. The holder 101 and HMD 201 are controlled by the CPU 6 of the basic device 1 via the holder I/Fs 9 and 109. The display controller 104, holder I/F 109, card I/F 112 and button I/F 114 are connected by a bus line 108.

Although details are not shown in the figures, the HMD 201 is a single-eye HMD in which images are viewed with one eye as described above in the prior art section. A liquid crystal display element is used, and this HMD 201 has an optical system which is designed for example such that images formed on the liquid crystal display element are reflected by a reflective mirror in front of the eyes and are enlarged and focused as full-color (260,000 color) virtual display images with an image display size of 13 inches and a resolution o SVGA (800×600 dots) on a virtual screen in a spatial position located 60 cm in front of the eyes. The abovementioned reflective mirror is installed in a movable system which allows the mirror to turn up so that the mirror does not cause any interference when the outside scene is viewed; furthermore, the system is a see-through type system which allows the outside scene to be viewed in cases where no image is being viewed.

In the portable information device of the present invention, in order to minimize the size, the basic device 1 is constructed so that information from the outside can be obtained from for example a flash memory card 121, which is an external recording medium via the card slot 113 of the holder 101 as required. Information from the flash memory card 121 is taken into the memory 5 of the CPU 6 via the card slot 113, card I/F 112, bus line 108, holder I/F 109 and holder I/F 9, and a high-definition image is displayed by the HMD 201 in accordance with the high-definition display controller 104, or a non-high-definition image is displayed by the liquid crystal panel 2 in accordance with the display controller 4, according to the input of operating information from the user by the pen touch input of the liquid crystal panel 2 or the buttons 130. Among the application software, the basic application software programs are stored in the ROM of the memory 5; software other than this basic application software can be taken in from external recording media or the like and stored in the RAM of the memory 5.

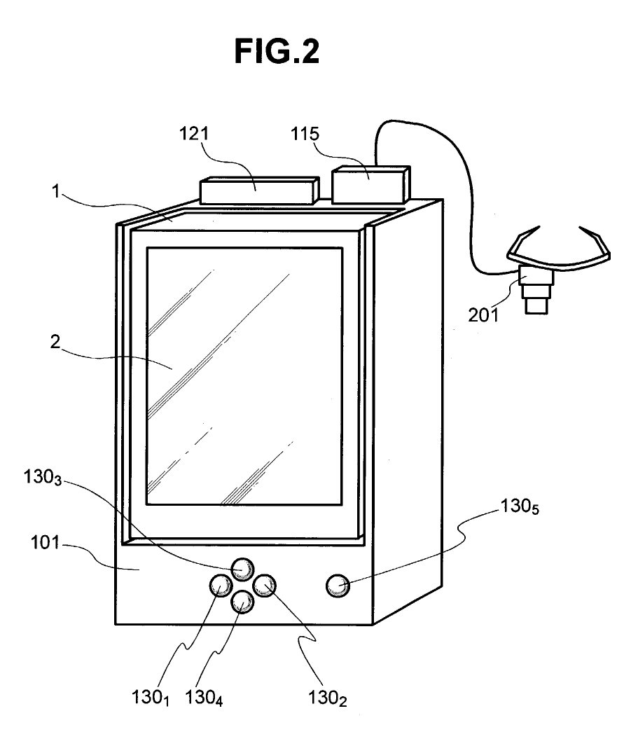

FIG. 2 is an external schematic diagram of the portable information device of the present invention. As is clear from FIG. 2, the basic device 1 is mounted on the holder 101, and the HMD 201 and flash memory card 121 are connected to the holder 101. A left button 130₁ and right button 130₂ corresponding to the left and right buttons of the mouse, a page up button 130₃ and page down button 130₄ which are page turning buttons, a 1 to 2 switching button for mode switching (described later) and the like, which form the buttons 130, are disposed on the housing of the holder 101. Although this is not shown in the figures, the basic device 1 is mounted on the holder 101 by engaging the connector 11 and connector 111; furthermore, the engagement of the connectors is naturally reinforced by structural means that provide mechanical reinforcement (not shown in the figures).

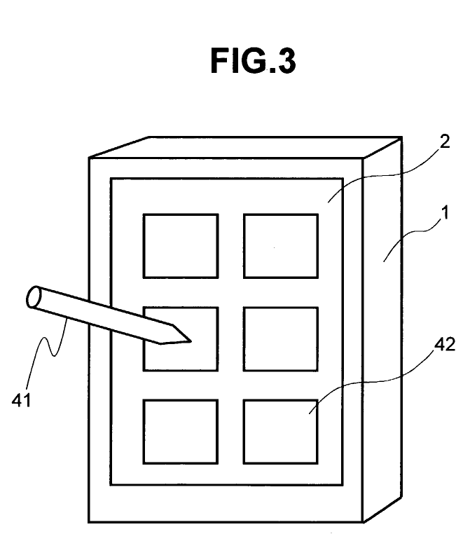

A plurality of use modes are afforded by combinations of the basic device and holder in the portable information device of the present invention. FIGS. 3 through 7 are figures that are used to illustrate the respective use modes. Five use modes, i. e., mode 0 through mode 4, will be described below using FIGS. 3 through 7, with reference also being made to FIGS. 1 and 2. Furthermore, in FIGS. 3 through 7, parts that are the same as in FIGS. 1 and 2 are labeled with the same symbols, and a description of such parts is omitted.

FIG. 3 is an external view which shows a use state of the basic device 1 corresponding to mode 0 among the five use modes. Mode 0 is a mode in which the basic device 1 (which is a PDA) is used by itself. Here, the basic device 1 is detached from the holder 101 and used, and is caused to act as an ordinary PDA.

As in the case of a general PDA, the liquid crystal panel 2 of the basic device 1 has a pen touch input function on the liquid crystal panel, and is also a pen touch input device with absolute coordinates that allow direct pointing to display content by means of a stylus pen 41.

When the basic device 1 is used alone, the CPU 6 displays an initial GUI screen on the liquid crystal panel 2 of the basic device 1. As is shown in FIG. 3, the user selects a plurality of icons 42 on the initial GUI screen of the liquid crystal panel 2 with the stylus pen 41, so that desired applications such as internet browsing, movie image/still image viewer, electronic books, personal information management or the like stored in the memory 5 are designated. The CPU 6 performs operational control in accordance with the application software designated by this pen touch input, and performs an operation in which the required display is displayed on the liquid crystal panel 2 by the display controller 4.

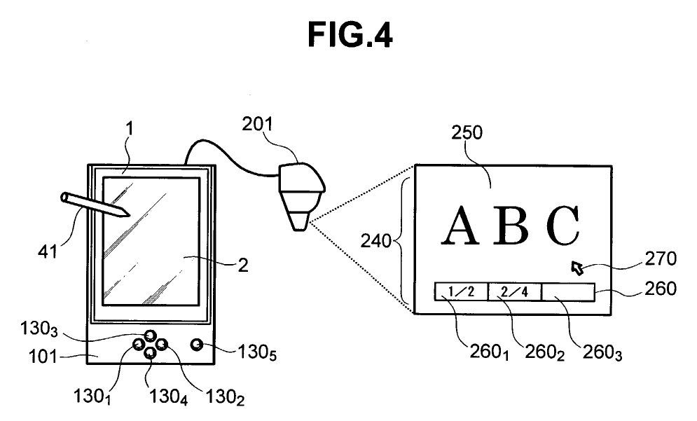

FIGS. 4 through 7 show use modes that are used when the basic device 1, holder 101 and HMD are used in combination as a WPC. FIG. 4 is an external view which shows the use state of the portable information device corresponding to mode 1.

Mode 1 will be described with reference to FIG. 4. When the basic device 1 is mounted on the holder 101 (which is an expansion device) as shown in FIG. 2, the CPU 6 detects the fact that the basic device 1 has been mounted on the holder 101 by means of a detection part (not shown in the figures). For example, although this is not shown in the figures, this can easily be detected by installing a mechanical switch that detects the engagement of the connector 11 and connector 111. Alternatively, it would also be possible to add a mounting detection signal line in which the power supply voltage of the battery 110 is applied to a signal line inside the connectors, and to detect the mounting or non-mounting according to whether the voltage of the mounting detection signal line is high or low. If the basic device 1 is mounted, the voltage of the mounting detection signal line is high.

When the CPU 6 detects that the basic device 1 has been mounted on the holder 101, the CPU 6 sends an initial GUI screen to the display controller 104 of the holder 101, and causes this screen to be displayed on the HMD 201. Furthermore, the CPU 6 places the liquid crystal panel 2 in a non-display state. In the case of the liquid crystal panel 2, pen touch input can be accomplished with the stylus pen 41; however, as in the case of the touch pad of a general notebook personal computer, the input pad has relative coordinates. Specifically, the pointer 270 appearing inside the display screen 250 of the display region 240 of the HMD 201 shown in FIG. 4 is caused to move by sliding the stylus pen 41 over the liquid crystal panel 2. A task bar 260 consisting of a plurality of icons is displayed within the display screen 250 of the HMD 201; for example, these icons include a mode 1 to 2 switching icon 260₁, a mode 2 to 4 switching icon 260₂, a movie image playback icon 260₃ and then like. Furthermore, desired icons are designated by performing a double touch operation of the stylus pen 41 which has the same effect as the clicking of the left button of a mouse in the desired icon positions. Such an input operation by means of the stylus pen 41 can easily be performed, since the HMD 201 is a single-eye HMD which is viewed with one eye. Even if the HMD is a two-eye HMD that is viewed with both eyes, the liquid crystal panel 2 of the basic device 1 can be viewed so long as the HMD is of see-through type, and the input operation can easily be performed. Furthermore, such pen touch input can be realized using universally known techniques; accordingly, this will not be described in further detail. When the icon 260ᵢ of the task bar 260 is designated by the user, the CPU 6 operates the application in the memory 5 that corresponds to the icon 260ᵢ.

In addition to operation by means of icons as described above, the holder 101 also has a plurality of buttons 130 on the housing. For example, the buttons 130 are constituted by a left button 130₁ which corresponds to the left button of a mouse, a right button 130₂ which corresponds to the right button of a mouse, a page up button 130₃ and page down button 130₄ for turning pages which are used when documents or drawings are viewed, a mode 1 to 2 switching button used for mode switching (described later) and the like. When these buttons are operated, the CPU 6 performs processing corresponding to the button in question, and controls the display controller 104 so that the display screen 250 of the HMD 201 is controlled.

The display screen 250 of the HMD 201 has a larger screen and a higher resolution than the screen of the basic device 1, and therefore offers the advantage of being able to display more information than is possible in the case of the basic device 1 alone.

As was described above, the input operation can be performed much more simply in the portable information device of the present invention than in a conventional WPC by making the liquid crystal panel 2 of the basic device 1 an input pad with relative coordinates similar to those of the touch pad of a common notebook personal computer.

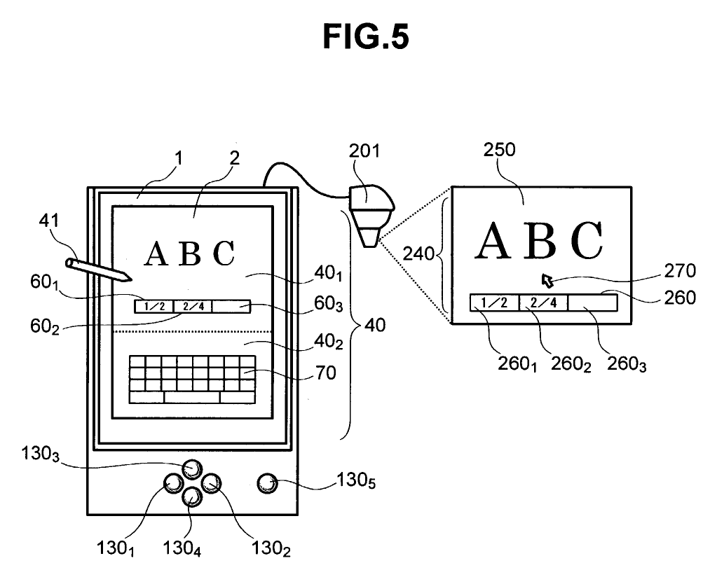

Next, mode 2 will be described. FIG. 5 is an external view showing the use state of the portable information device corresponding to mode 2. In mode 2, as is shown in FIG. 5, the display region 40 (a region of 240×320 dots) of the liquid crystal panel 2 is split into two, upper and lower regions. A reduced screen 50 of the display screen 250 of the HMD 201 is displayed in the upper display region 40₁ (a region of 240×180 dots), and a software keyboard 70 is displayed in the lower display region 40₂ (a region of 240×140 dots), so that operations can be performed using the software keyboard 70 while viewing the reduced screen 50.

If a double touch operation which is a clicking operation is performed by means of the stylus pen 41 in the position of the mode 1-2 switching icon 260₁ within the task bar 260 in the state of mode 1, the CPU 6 uses image conversion application software stored in the memory 5 to convert the high-definition image of the display screen 250 of the HMD 201 into a reduced display screen showing a non-high-definition image, and controls the display controller 4 of the basic device 1 so that this image is displayed in the upper display region 40₁ (a region of 240×180 dots) of the liquid crystal panel 2. Furthermore, the software keyboard 70 is displayed in the lower display region 40₂ (a region of 240×140 dots) of the liquid crystal panel 2. The pen touch panel of the liquid crystal panel 2 uses the same absolute coordinate input as in cases where the basic device 1 is used alone, so that operating input and character input can be performed using the software keyboard 70 displayed in the lower display region 40₂. Since information input by the software keyboard 70 is displayed in the upper display region 40₁, key input can be performed with the same feeling as in a personal computer. Furthermore, the key input information is naturally also displayed on the display screen 250 of the HMD 201 which is the main screen. Moreover, it goes without saying that the designation of icons in the task bars displayed on the abovementioned reduced screen and main screen can be accomplished by touching the icons 60ᵢ in the task bar 60 on the reduced screen with the stylus pen 41.

Since the HMD is a single-eye HMD, the use of a software keyboard 70 is easy; furthermore, if the reflective mirror of the HMD that is installed in front of the eyes is caused to spring upward, viewing with both eyes is possible, so that operation is further facilitated.

In the above description, image conversion was performed using software. However, the present invention is not limited to this; it would also be possible to perform image conversion using universally known hardware.

By using the above construction, it is possible to perform key input with the same key operating feeling as in a personal computer, so that the operating characteristics can be greatly improved. Furthermore, since a reduced image 50 of the HMD can be displayed on the liquid crystal panel 2 of the basic device 1, information that is input via the card slot 113 can also be viewed at a glance without mounting the HMD. In this case, since a page up button 130₃ and page down button 130₄ that can turn pages are disposed on the housing of the holder 101, the device is made more effective by this synergistic effect. Furthermore, since a mode 1 to 2 switching button 130₅ which has the same function as the mode 1 to 2 switching icon 260₁ is disposed on the housing of the holder 101, switching from mode 1 to mode 2 can easily be accomplished in the state of mode 1 without mounting the HMD on the head and designating the mode 1 to 2 switching icon 260₁, so that viewing information input via the card slot 113 at a glance is made simpler.

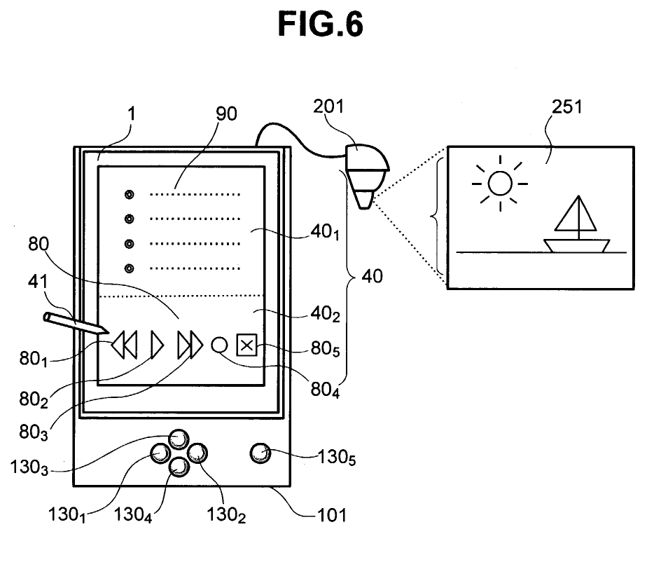

Next, mode 3 will be described. FIG. 6 is an external view which shows the use state of the portable information device corresponding to mode 3. As is shown in FIG. 6, mode 3 is a movie image playback mode which is a state in which movie images are played back. In this mode, a movie image playback screen 251 is displayed in the display screen region 240 of the HMD 201. In the liquid crystal panel 2 of the basic device 1, the display of display content attribute information (so-called profile information) for the movie image playback screen 251 is performed in the upper display region 40₁, and a plurality of control icons 80 for movie image playback are displayed in the lower display region 40₂. Furthermore, movie image playback control can be designated by touching the control icons 80ᵢ with the stylus pen 41.

The state of mode 3 can be entered by operating the movie image playback icon 260₃ in the state of mode 2 so that the movie image playback software is started, or by switching from mode 1 to mode 2 by means of the mode 1 to 2 switching icon 260₁ in the task bar 260 during the use of the abovementioned movie image playback software in the state of mode 1. The HMD 201 displays a window for the abovementioned movie image playback software; however, the basic device 1 does not display a reduced image of this, but rather displays control icons 80 and display content attribute information (profile information). For example, the plurality of movie image playback control icons 80 displayed on the liquid crystal panel 2 of the basic device 1 include a fast rewind button 80₁, a playback button 80₂, a fast forward button 80₃, a stop button 80₄, a movie image playback end button 80₅ and the like.

Thus, in mode 3, movie image playback display content attribute information and control icons are displayed on the liquid crystal panel 2, and movie image playback can be controlled using such information and control icons; accordingly, the operating characteristics are greatly improved compared to those of a conventional WPC.

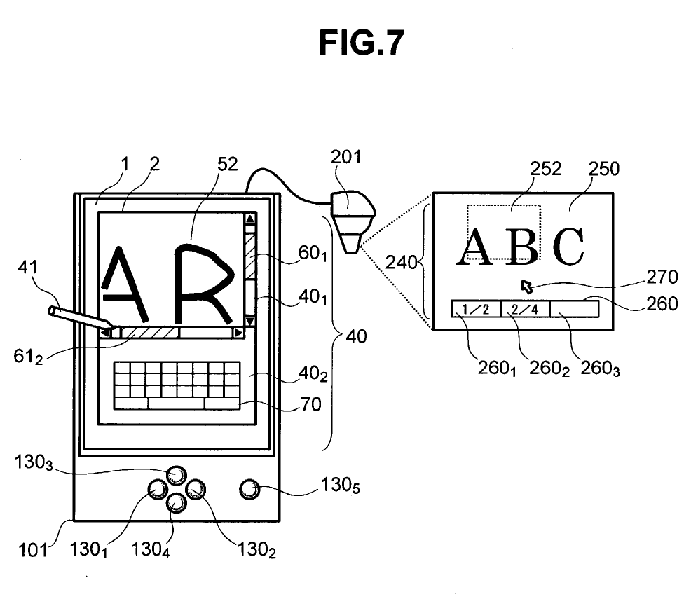

Next, mode 4 will be described. FIG. 7 is an external view which shows the use state of the portable information device corresponding to mode 4. As is shown in FIG. 7, mode 4 is a mode in which there is a partial display of a partial display region 252 surrounded by a dotted line in the display screen 250 of the HMD 201, in the upper display region 40₁ of the liquid crystal panel 2 of the basic device 1 in the state of mode 2. 52 indicates this partial display screen. The partial display position can be varied by moving the vertical scroll bar icon 61₁ and the transverse scroll bar icon 61₂ in the vertical or transverse directions. Furthermore, a software keyboard 70 is displayed in the lower display region 40₂ in the same manner as in mode 2.

A shift into the state of mode 2 can be accomplished by clicking on the mode 2 to 4 switching icon 260₂ (or 60₂) in the task bar 260 (or 60) from the state of mode 2.

As was described above, the screen of the partial display region 252 of the HMD 201 can be displayed on the liquid crystal panel 2 by reproducing the dots of this portion “as is”. Such a display conversion can easily be accomplished using software; accordingly, a detailed description will not be given. Of course, an image conversion part could also be constructed using hardware.

If this is done, a portion of the high-definition image can be displayed by the liquid crystal panel 2 without reducing the number of dots, and while scrolling through the entire high-definition image, without mounting the HMD.

A full keyboard ordinarily used in personal computers (PC) was shown in FIGS. 5 and 7 as the software keyboard of mode 2 and mode 4 shown in FIGS. 5 and 7. However, the present invention is not limited to this; a simplified character input software keyboard using numeral keys and control keys may also be used.

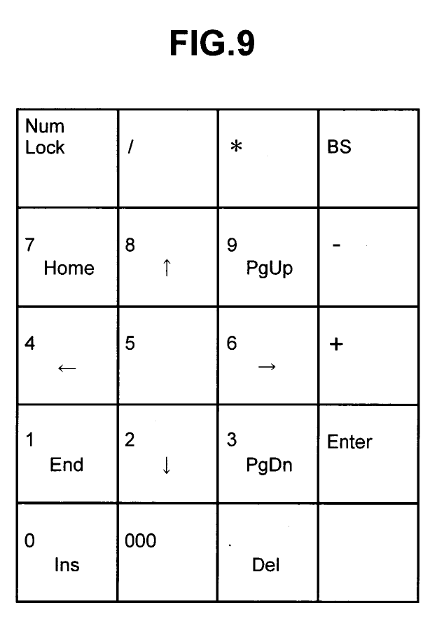

FIG. 9 shows one example of a simplified character input software keyboard. This simplified character input keyboard corresponds to the ten-key keyboard that is disposed on the right side of the full keyboard ordinarily used in a personal computer (PC). Furthermore, as in a system that is widely used in (for example) portable telephones, a plurality of characters are assigned to one numerical key icon (this is not shown in FIG. 9), and character input is performed using the numerical icons. For switching to a mode that performs character input, for example, an icon that switches to such a character input mode is provided in the simplified character input keyboard (this is not shown in FIG. 9), or such an icon is provided separately from the simplified character input keyboard in the lower display region 40₂ of the liquid crystal panel 2 on which the simplified character input software keyboard is displayed. Of course, it would also be possible to select this using a menu screen. Furthermore, in FIG. 9, BS is an abbreviation for back space, Del is an abbreviation for delete, Ins is an abbreviation for insert, PgUP is an abbreviation for page up, and PgDn is an abbreviation for page down. The functions of these icons are universally known, and no further description will be given.

Short character sequences such as URL or the like can easily be input using a software keyboard constructed in this manner, and the internet can be entered via a PHS data communications card 122 connected to the card slot 113, so that desired information from desired sites can easily be obtained; thus, the operating characteristics can be greatly improved compared to those of a conventional WPC.

In the above description, the liquid crystal panel 2 (with a pen touch function) of the basic device 1 having a PDA function was used as the input part for operating information for the portable information device with a WPC function, character information and the like. However, in a WPC consisting of a WPC main body and an HMD, it is clear that it would also be possible to install a display part with a pen touch function in the WPC main body.

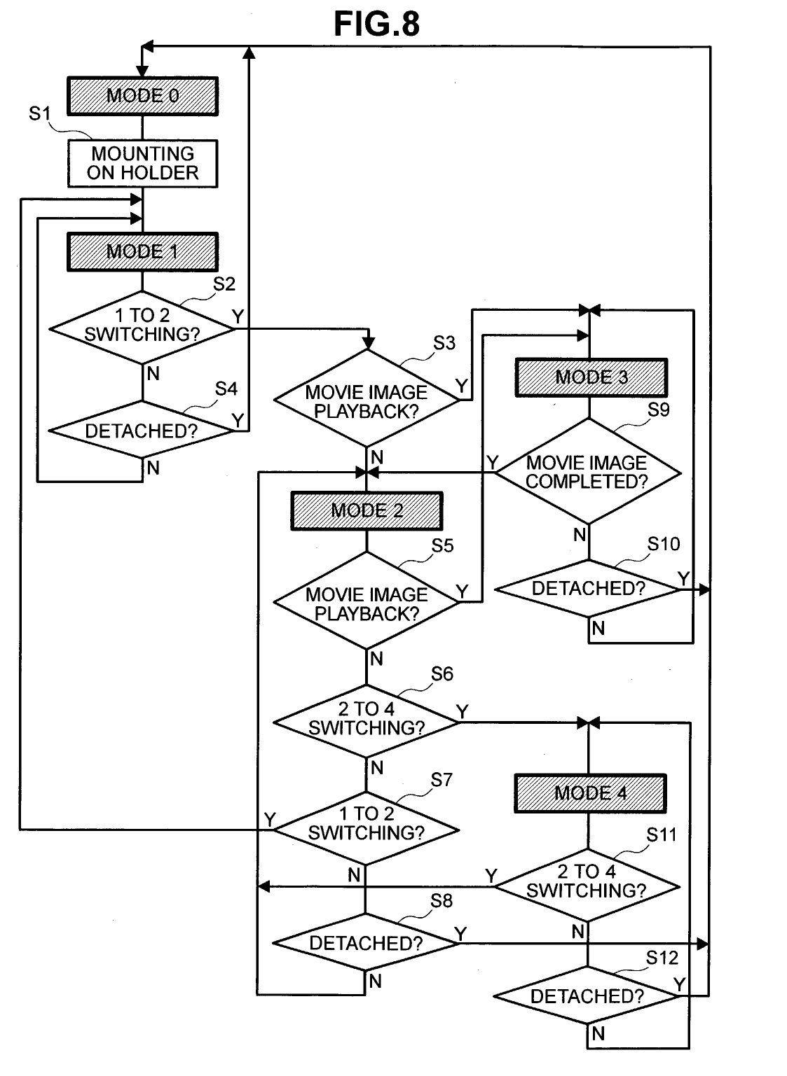

Next, one embodiment of the transition processing of the abovementioned mode states will be described using the mode state transition diagram shown in FIG. 8 in order to simplify the description.

In FIG. 8, it is first assumed that the portable information device is in mode 0, in which the basic device 1 is used alone. When the basic device 1 is mounted on the holder 101 in step 1 (“step” will hereafter be abbreviated to “S”), the portable information device shifts to the state of mode 1. When the 1 to 2 switching icon 260₁ is clicked on in the state of mode 1 (S2), a check is made as to whether or not the device is in a movie image playback state (S3), and if the device is in such a movie image playback state, the device shifts to mode 3. If the device is not in this movie image playback state in S3, the device shifts to mode 2. If the 1 to 2 switching icon 260₁ is not clicked on in S2, a check is made as to whether or not the basic device 1 has been detached from the holder 101 (S4). If the basic device 1 has been detached, the device shifts to mode 0; if not, the state of mode 1 is continued.

If the movie image playback icon 260₃ (or 60₃) is clicked on in the state of mode 2, the device shifts to mode 3; if not, a check is made as to whether or not the 2 to 4 switching icon 260₂ (or 60₂) has been clicked on (S6) . If the 2 to 4 switching icon 260₂ (or 60₂) has been clicked on, the device shifts to mode 4; if not, a check is made as to whether or not the 1 to 2 switching icon 260₁ (or 60₁) has been clicked on (S7). If this icon has been clicked on, the device shifts to mode 1; if not, a check is made in S8 as to whether or not the basic device 1 has been detached from the holder 101. If the basic device 1 has been detached, the device shifts to mode 0; if not, the state of mode 2 is continued.

If the movie image playback end icon 80₅ is clicked on in the state of mode 3 which is the movie image playback mode (S9), the device shifts to mode 2; if not, a check is made in S10 as to whether or not the basic device 1 has been detached from the holder 101. If the basic device 1 has been detached, the device shifts to mode 0; if not, the state of mode 3 is continued.

If the 2 to 4 switching icon 260₂ (or 60₂) is clicked on in the state of mode 4 (S11), the device shifts from the state of mode 4 to mode 2; if not, a check is made in S12 as to whether or not the basic device 1 has been detached from the holder 101. If the basic device 1 has been detached, the device shifts to mode 0; if not, the state of mode 4 is continued.

In the above description, the portable information device consisted of a basic device, an expansion device and an HMD. However, it is clear that the effect is the same if the present invention is applied to a portable information device system in which the portable information device consists of a basic device and an expansion device, and this portable information device is used by being connected to an HMD. Furthermore, it is clear that the portable information device may be a device in which the basic device and expansion device are integrated.

As was described above, a display device in which a display screen and a pen touch input function using (for example) a stylus pen or the like are integrated is installed separately from the HMD that displays a high-definition large screen, and this display device is used as a key input part. As a result, the input operation of operating information is a intuitive input or direct input operation, and can quickly be performed. Furthermore, a portable information device which is a WPC that the display content to be easily viewed at a glance by the abovementioned display device without mounting the HMD can be provided.

FIG. 1

2 LIQUID CRYSTAL PANEL (WITH PEN TOUCH INPUT)

4 DISPLAY CONTROLLER WITH VRAM

7 TOUCH I/F

9 HOLDER I/F

10 BATTERY

104 DISPLAY CONTROLLER WITH VRAM

109 HOLDER I/F

110 BATTERY

112 CARD I/F

113 CARD SLOT

114 BUTTON I/F

121 FLASH MEMORY CARD

122 PHS DATA COMMUNICATIONS CARD

130 BUTTON

FIG. 8

MODE 0

S1 MOUNTING ON HOLDER

MODE 1

S2 1 TO 2 SWITCHING?

S3 MOVIE IMAGE PLAYBACK?

S4 DETACHED?

MODE 2

S5 MOVIE IMAGE PLAYBACK?

S6 2 TO 4 SWITCHING?

S7 1 TO 2 SWITCHING?

S8 DETACHED?

MODE 3

S9 MOVIE IMAGE COMPLETED?

S10 DETACHED?

MODE 4

S11 2 TO 4 SWITCHING?

S12 DETACHED?

What is claimed is:

1. A portable information device comprising a portable main body part, and a head-mounted display which is connected to said portable main body part, and which is mounted on the head or face;
wherein said main body part comprises:
an input display part which displays to the outside image information consisting of a smaller amount of data than the image information that is displayed on said head-mounted display, and which inputs operating information from the outside on the screen that is displayed;
an output part which outputs image information to said head-mounted display; and
a control part which controls the image information displayed on said head-mounted display on the basis of the operating information that is input in said input display part.

2. The portable information device according to claim 1, wherein said main body part comprises:
a first display processing part which performs image display processing when image information is displayed on said input display part; and
a second display processing part which performs image display processing when image information is displayed on said head-mounted display; and
said control part reads out information from a memory part in which information is stored, and supplies this read-out information to said first and second display processing parts as information corresponding to the image information that is displayed in said input display part and said head-mounted display.

3. The portable information device according to claim 1, wherein said control part performs a control action so that information is processed in association with the image information that is displayed on said head-mounted display on the basis of the input in said input display part regardless of the image information that is displayed in said input display part.

4. The portable information device according to claim 1, wherein said control part performs a control action so that the image information that is displayed in said input display part is information which includes a content similar to that of the image information that is displayed in said head-mounted display, and in which the amount of data is reduced.

5. The portable information device according to claim 1, wherein said control part controls the image information that is displayed in said input display part so that said information is added information or control information for the image information that is displayed in said head-mounted display, and controls the display of image information in said head-mounted display by means of the input in said input display part.

6. The portable information device according to claim 1, wherein said control part controls the image information that is displayed in said input display part so that this information is image information constituting a portion of the image information that is displayed in said head-mounted display, and controls the remaining portion of the image information that is displayed on said head-mounted display so that this information is displayed on said input display part.

7. The portable information device according to claim 1, wherein said control part controls the image information that is displayed on said input display part so that the association with the images that are displayed on said head-mounted display is switched, thus allowing a plurality of different types of image information to be displayed on said input display part.

8. The portable information device according to claim 1, wherein the image information that is displayed on said input display part is image information that is not included in the image information displayed on said head-mounted display, and is a keyboard image that is used to process information on the image information of said head-mounted display.

9. A portable information device which can connect a head-mounted display that is mounted on the head or face, comprising:
an input display part which displays to the outside image information consisting of a smaller amount of data than the image information that is displayed on said head-mounted display, and which inputs operating information from the outside in a displayed screen;
an output part which outputs image information to said head-mounted display; and
a control part which controls the image information that is displayed on said head-mounted display on the basis of the operating information that is input in said input display part.

10. The portable information device according to claim 9, wherein said control part performs a control action so that information is processed in association with the image information that is displayed on said head-mounted display on the basis of the input in said input display part regardless of the image information that is displayed in said input display part.

11. The portable information device according to claim 9, wherein said control part controls the image information that is displayed in said input display part so that this information is information which includes a content that is similar to that of the image information that is displayed in said head-mounted display, and in which the amount of data is reduced.

12. The portable information device according to claim 9, wherein said control part controls the image information that is displayed in said input display part so that said information is added information or control information for the image information that is displayed in said head-mounted display, and controls the display of image information in said head-mounted display by means of the input in said input display part.

13. The portable information device according to claim 9, wherein said control part controls the image information that is displayed in said input display part so that this information is image information constituting a portion of the image information that is displayed in said head-mounted display, and controls the remaining portion of the image information that is displayed on said head-mounted display so that this information is displayed on said input display part.
